(19) United States
(12) Patent Application Publication
(10) Pub. No.: US 2016/0269286 A1
(43) Pub. Date: Sep. 15, 2016

(54) METHOD AND APPARATUS FOR TRANSMITTING DATA IN NETWORK SYSTEM

(71) Applicant: Tencent Technology (Shenzhen) Company Limited, Shenzhen (CN)

(72) Inventors: FEIHU ZHOU, Shenzhen (CN); Liqiang XIE, Shenzhen (CN); Yingpai SONG, Shenzhen (CN); Ming RAO, Shenzhen (CN)

(21) Appl. No.: 15/158,382

(22) Filed: May 18, 2016

Related U.S. Application Data
(63) Continuation of application No. PCT/CN2014/095217, filed on Dec. 27, 2014.

(30) Foreign Application Priority Data
Jan. 8, 2014 (CN) 201410008150.7

(51) Int. Cl. H04L 12/741; H04L 29/08; H04L 12/721

(52) U.S. Cl. CPC H04L 45/74; H04L 45/38; H04L 67/142

(57) ABSTRACT

An acceleration node for routing a data packet includes one or more processors and memory storing one or more programs for execution by the one or more processors. The acceleration node receives a first data packet from a first network node; and, in response to receiving the first data packet, obtains a first session identifier from the first data packet; identifies a second network node to which the first data packet is to be sent, including searching for routing information that corresponds to the first session identifier; and sends the first data packet to the second network node.

### RELATED APPLICATIONS

This application is a continuation application of PCT Patent Application No. PCT/CN2014/095217, entitled “METHOD AND APPARATUS FOR TRANSMITTING DATA IN NETWORK SYSTEM” filed on Dec. 27, 2014, which claims priority to Chinese Patent Application Serial No. 201410008150.7, entitled “METHOD AND APPARATUS FOR TRANSMITTING DATA IN NETWORK SYSTEM,” filed on Jan. 8, 2014, both of which are incorporated herein by reference in their entirety.

### TECHNICAL FIELD

This application relates to data transmission technologies, and in particular, to methods and devices for transmitting data in a network system.

### BACKGROUND

When a user uses a mobile client for communication and other actions, the client needs to send, through a mobile network, a data packet of the user to a server that receives data packets, and a communication process is completed only after the data packet of the user arrives in the server and is processed. The network environment is very complicated when the mobile client communicates with the server. A common problem is that the mobile client and the server are distant from each other, and data packets are easily affected by network congestion and packet loss during long-distance network transmission; the problem is more likely to occur during interprovincial transmission and inter-carrier transmission of data packets. This leads to instability and a low success rate of data packet transmission in a communication process between the mobile client and the server.

Therefore, it is necessary to provide a new data transmission manner, which can accelerate the data transmission process.

### SUMMARY

In accordance with some embodiments, a method for routing a data packet is performed at an acceleration node with one or more processors and memory. The method includes receiving a first data packet from a first network node; and, in response to receiving the first data packet: obtaining a first session identifier from the first data packet; identifying a second network node to which the first data packet is to be sent, including searching for routing information that corresponds to the first session identifier; and sending the first data packet to the second network node.

In accordance with some embodiments, an acceleration node for routing a data packet includes one or more processors; and memory storing one or more programs for execution by the one or more processors. The one or more programs include instructions for: receiving a first data packet from a first network node; and, in response to receiving the first data packet: obtaining a first session identifier from the first data packet; identifying a second network node to which the first data packet is to be sent, including searching for routing information that corresponds to the first session identifier; and sending the first data packet to the second network node.

In accordance with some embodiments, a non-transitory computer readable storage medium for routing a data packet stores one or more programs for execution by one or more processors of an acceleration node. The one or more programs include instructions for: receiving a first data packet from a first network node; and, in response to receiving the first data packet: obtaining a first session identifier from the first data packet; identifying a second network node to which the first data packet is to be sent, including searching for routing information that corresponds to the first session identifier; and sending the first data packet to the second network node.

### BRIEF DESCRIPTION OF THE DRAWINGS

The aforementioned features and advantages as well as additional features and advantages thereof will be more clearly understood hereinafter as a result of a detailed description of preferred embodiments when taken in conjunction with the drawings.

FIG. 1 is a schematic architectural diagram of a data transmission system in accordance with some embodiments.

FIG. 2A is a block diagram of an acceleration node of the data transmission system in accordance with some embodiments.

FIG. 2B is a block diagram of a memory of an acceleration node in accordance with some embodiments.

FIG. 3 is a block diagram of an application server of the data transmission system in accordance with some embodiments.

FIG. 4 is a block diagram of a client of the data transmission system in accordance with some embodiments.

FIG. 5 is a flowchart of a method for transmitting data in a network system in accordance with some embodiments.

FIG. 6 is a flowchart of a method for transmitting data in a network system in accordance with some embodiments.

FIG. 7 is a flowchart of a method for transmitting data in a network system in accordance with some embodiments.

FIG. 8 is a flowchart of a method for transmitting data in a network system in accordance with some embodiments.

FIG. 9 is a flowchart of a method for transmitting data in a network system in accordance with some embodiments.

FIG. 10 is a flowchart of a method for transmitting data in a network system in accordance with some embodiments.

FIG. 11 is a flowchart of a method for transmitting data in a network system in accordance with some embodiments.

FIG. 12 is a flowchart of a method for transmitting data in a network system in accordance with some embodiments.

FIG. 13 is a structural block diagram of an apparatus for transmitting data in a network system in accordance with some embodiments.

FIGS. 14A-14C are flow diagrams illustrating a method for routing a data packet in accordance with some embodiments.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

In order to further illustrate the technical means adopted by the present application to achieve the intended invention purpose and the efficacy thereof, the following describes the specific embodiments, structures, features, and efficacy according to the present application in detail with reference to the accompanying drawings and preferred embodiments.

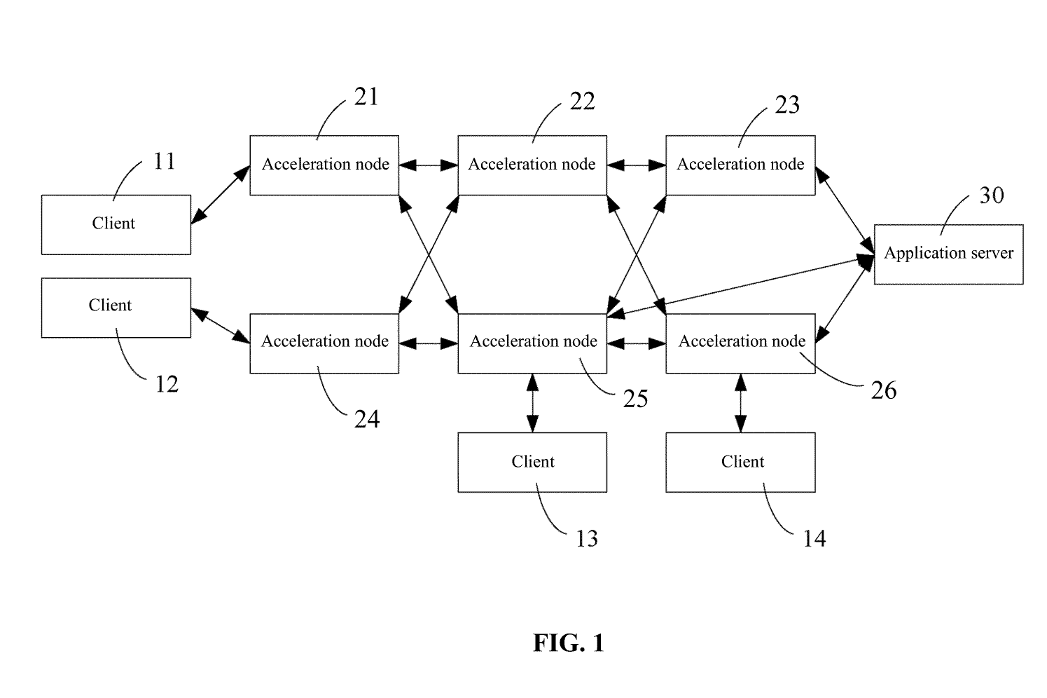

FIG. 1 is a schematic architectural diagram of a data transmission system in accordance with some embodiments. As shown in FIG. 1, a data transmission system includes: a client, an acceleration node, and an application server 30. In FIG. 1, the client includes, for example, a client 11, a client 12, a client 13, and a client 14. In FIG. 1, the acceleration node includes, for example, an acceleration node 21, an acceleration node 22, an acceleration node 23, an acceleration node 24, an acceleration node 25, an acceleration node 26, and additional acceleration nodes (not shown).

### Role of the Acceleration Node and Transmission Type of a Data Packet

The function of an acceleration node is to forward a data packet from a client or another acceleration node to the application server 30 or another acceleration node. For each data packet, the transmission type thereof in the acceleration node, or the role played by the acceleration node in a task of transmitting the current data packet, may be different. The role of the acceleration node or the transmission type of the data packet in the acceleration node depends on a transmission path of the current data packet.

For a data packet currently processed, the transmission type thereof in a current acceleration node depends on the type of a source node of the data packet and the type of a node to which the data packet is to be transmitted. Specifically, reference can be made to the following Table 1.

TABLE 1
Distinction between transmission types of a data packet

| | | Types of source nodes | |
|---|---|---|---|
| | | of the data packet | |
| Transmission types of a data packet | | Client | Acceleration node |
| Types of nodes to | Acceleration node | Access | Transmission |
| which the data | Application server | Access + | Session |
| packet is to be | | session | |
| transmitted | | | |

If the source node of a data packet is a client and the type of the node to which the data packet is to be transmitted is acceleration node, the transmission type of the data packet in the current acceleration node is access.

If the source node of a data packet is an acceleration node and the type of the node to which the data packet is to be transmitted is acceleration node, the transmission type of the data packet in the current acceleration node is transmission.

If the source node of a data packet is a client and the type of the node to which the data packet is to be transmitted is application server, the transmission type of the data packet in the current acceleration node is access+session.

If a source node of a data packet is an acceleration node and the type of a node to which the data packet is to be transmitted is application server, the transmission type of the data packet in a current acceleration node is session.

An uplink data packet is used as an example for the foregoing description. In some embodiments, a downlink data packet uses a transmission path identical with that of the uplink data packet, and in the same node, the transmission type of the data packets is the same.

For example, the acceleration node 21 is directly connected with the client 11, and a data packet from the client 11 can only be forwarded to the acceleration node 22 or the acceleration node 25. In the acceleration node 21, the transmission type of a data packet from the client 11 is access. Similarly, in the acceleration node 24, the transmission type of a data packet from the client 12 is access.

By using the acceleration node 25 as an example, the transmission type of a data packet from the acceleration node 24 or the acceleration node 21 is transmission. The transmission type of a data packet from the client 13 is access. The acceleration node 26 is directly connected with the application server 30, and the transmission type of the data packet from the acceleration node 22 or the acceleration node 25 to the application server 30 is session. However, the acceleration node 26 is also connected with the client 14, and in the acceleration node 26, the transmission type of a data packet from the client 14 to the application server 30 is access+session.

### Connection Pool

In some embodiments, a certain number of long connections is maintained between the acceleration nodes or between the acceleration nodes and the application server 30. It can be understood that, the long connection herein refers to, for example, a transmission control protocol (TCP) long connection. All the long connections between every two nodes form a connection pool. In some embodiments, the number of the connection pools is set according to specific requirements. For example, a connection pool including 30,000 long connections may be maintained between two acceleration nodes or between the acceleration nodes and the application server.

Connections of an acceleration node may be classified into forward connections and backward connections. The forward connections refer to connections with nodes closer to the application server 30 in the transmission path. The backward connections refer to connections with nodes closer to the client in the transmission path.

For example, a connection between the acceleration node 21 and the acceleration node 22 is a forward connection of the acceleration node 21, and is a backward connection of the acceleration node 22.

It can be understood that, each acceleration node can be deployed as one or more servers.

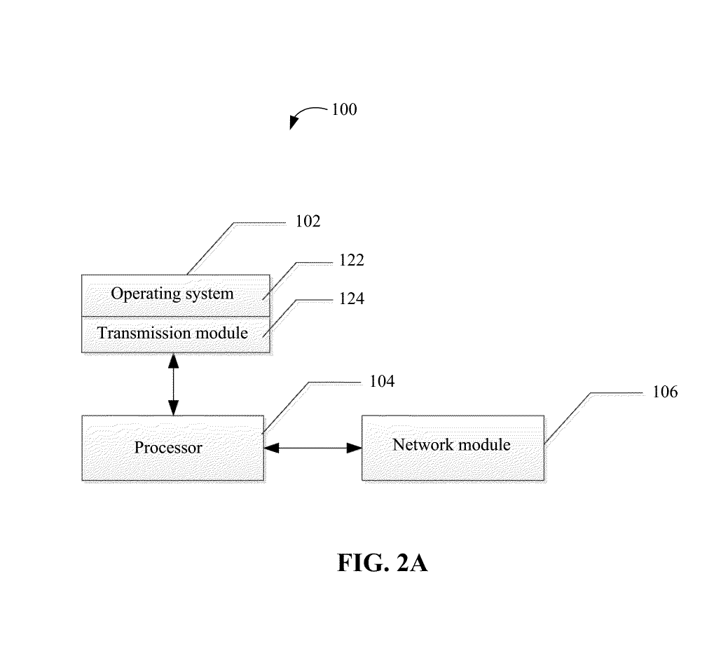

Refer to FIG. 2A, which is a structural block diagram of an acceleration node 100 in accordance with some embodiments. As shown in FIG. 2A, the acceleration node 100 includes: a memory 102, one or more processors 104, and a network module 106. It can be understood that, the structure shown in FIG. 2A is only schematic, and does not limit the structure of the acceleration node 100. For example, the acceleration node 100 may further include more or less components than those shown in FIG. 2A, or have a configuration different from that shown in FIG. 2A.

The memory 102 can be used for storing a software program and a module. The processor 104 executes various functional applications and data processing by running the software program and module stored in the memory 102. In some embodiments, the memory 102 includes a high-speed random access memory and/or a nonvolatile memory, such as one or more magnetic storage devices, flash memories, and/or other nonvolatile solid-state memories. Examples of the network include, but are not limited to, the Internet, an enterprise intranet, a local area network, a mobile communications network, and a combination thereof.

The transmission module 106 is used for receiving and sending a network signal. The network signal may include a wireless signal or a wired signal. For example, the network signal is a wired network signal. In some embodiments, the transmission module 106 includes elements, such as one or more processors, a random access memory, a converter, and a crystal oscillator.

The software program and module include: an operating system 122 and a transmission module 124. The operating system 122 may be, for example, LINUX, UNIX, or WINDOWS, which may include various software components and/or drives for managing system tasks (for example, memory management, storage device control, and power management), and can communicate with various hardware or software components, so as to provide a running environment for other software components. The transmission module 124 runs over the operating system 122, listens, by using a network service of the operating system 122, to a request from the network, receives a data packet sent by a client, an application server, or another acceleration node, and forwards the data packet.

FIG. 2B is a block diagram of the memory 102 of an acceleration node in accordance with some embodiments.

In some embodiments, the memory 102 includes the operating system 122 and the transmission module 124 described above with respect to FIG. 2A.

In some embodiments, in addition to, or instead of, the operating system 122 and the transmission module 124, the memory 102 includes one or more of: application(s) 130 and database 146.

The memory 102 includes one or more applications 130. In some embodiments, the one or more applications 130 include a data routing module 132. The data routing module 132 includes the following modules, or a subset or a superset thereof:
data receiving module 134 for receiving data from a network node (e.g., a client, another acceleration node, or an application server);
session identifier module 136 for generating or obtaining a session identifier;
routing information module 138 for obtaining and/or storing routing information; and
transmission type module 142 for determining a transmission type for a data packet.

In some embodiments, the routing information module 138 includes a database interface 140, which assists in searching, retrieving, and storing data in a database (e.g., database 146).

The database 146 includes routing information for one or more session identifiers. In some embodiments, the routing information is stored using state machines (e.g., Table 2 described below). In some embodiments, routing information for a respective session identifier includes information identifying one or more network nodes (e.g., a forward network node and/or a backward network node) to which a data packet that corresponds to the respective session identifier.

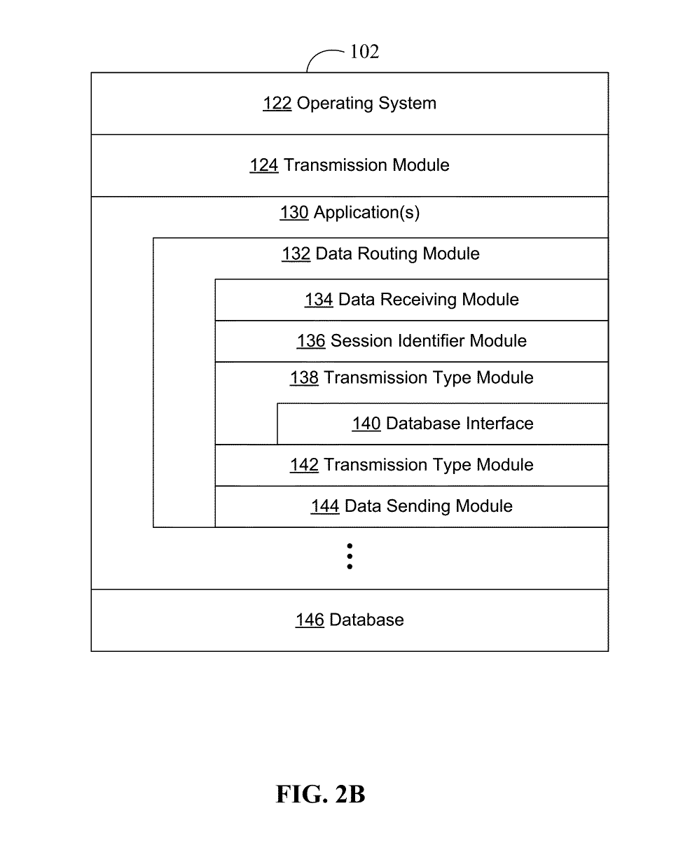

Refer to FIG. 3, which is a structural block diagram of an application server 30 in accordance with some embodiments. As shown in FIG. 3, the application server 30 is substantially similar to the acceleration node, and their difference lies in that the application server 30 does not include the transmission module 124 but includes an application service module 126. The application service module 126 runs over the operating system 122, listens, by using a network service of the operating system 122, a data packet from an acceleration node, performs corresponding data processing according to content of the data packet, and returns a processing result to the corresponding acceleration node. The application service module 126 implements a certain network service based on the data packet (e.g., a service of forwarding text, voice, or video messages).

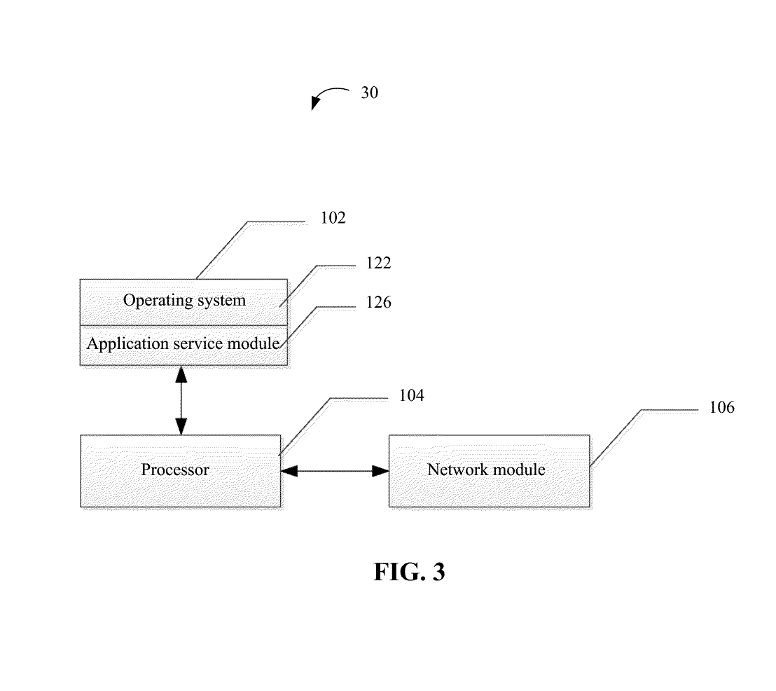

Refer to FIG. 4, which is a structural block diagram of a client 20 (e.g., a mobile terminal) in accordance with some embodiments. As shown in FIG. 4, the client 20 includes a memory 202, a memory controller 204, one or more (only one shown in FIG. 4) processors 206, a peripheral interface 208, a radio frequency module 210, a positioning module 212, a camera module 214, an audio module 216, a touch screen 218 and a key module 220. The components communicate with each other through one or more communication buses/signal lines 222.

It can be understood that, the structure shown in FIG. 4 is only schematic, and the client 20 may also include more or less components than those shown in FIG. 4, or have a configuration different from that shown in FIG. 4. The components shown in FIG. 4 may be implemented by using hardware, software or a combination thereof.

The memory 202 stores a software program and a module. The processor 206 executes various functional applications and data processing by running the software program and module stored in the memory 202. In some embodiments, the memory 202 includes a high-speed random access memory and/or a nonvolatile memory, such as one or more magnetic storage devices, flash memories, or other nonvolatile solid-state memories. In some embodiments, access of the one or more processors 206 and other possible components to the memory 202 is performed under the control of the memory controller 204.

A person of ordinary skill in the art can understand that, with respect to the one or more processors 206, all other components are peripherals, and the one or more processors 206 and the peripherals are coupled through a plurality of peripheral interfaces 208. The peripheral interfaces 208 may be implemented based on the following standards: Universal Asynchronous Receiver/Transmitter (UART), General Purpose Input Output (GPIO), Serial Peripheral Interface (SPI) or Inter-Integrated Circuit (I2C), but are not limited to these standards. In some examples, the peripheral interfaces 208 can only include buses. In some other examples, the peripheral interfaces 208 may further include other elements, such as one or more controllers, such as a display controller for connection to a liquid crystal display panel or a memory controller for connection to the memory. In addition, the controllers may further be separated from the peripheral interfaces 208, and be integrated in the processor 206 or corresponding peripherals. In other words, in some embodiments, the peripheral interfaces 208, the processor 206, and the memory controller 204 can be implemented in a single chip, and in some other embodiments, can be implemented by using separate chips.

The radio frequency module 210 is used for receiving and sending electromagnetic waves, to achieve conversion between electromagnetic waves and electrical signals, thereby communicating with a communication network or other devices. The radio frequency module 210 may include various existing circuit elements for performing these functions, such as an antenna, a radio frequency transceiver, a digital signal processor, an encryption/decryption chip, a subscriber identity module (SIM) card, a memory and the like. The radio frequency module 210 may communicate with various networks, such as the Internet, an enterprise intranet, and a wireless network or communicate with other devices through a wireless network. The wireless network may include a cellular telephone network, a wireless local area network or a metropolitan area network. The wireless network may use various communication standards, protocols, and technologies, which include, but are not limited to, Global System for Mobile Communication (GSM), Enhanced Data GSM Environment (EDGE), wideband code division multiple access (W-CDMA), Code division access (CDMA), time division multiple access (TDMA), Bluetooth, Wireless Fidelity (WiFi) (for example, Institute of Electrical and Electronic Engineers (IEEE) 802.11a, IEEE 802.11b, IEEE802.11g and/or IEEE 802.11n), Voice over Internet Protocol (VoIP), Worldwide Interoperability for Microwave Access (Wi-Max), other protocols for emails, instant messaging, and short data packets, and any other appropriate communication protocol, or even may include protocols that have not been developed yet.

The positioning module 212 is used for acquiring a current position of the client 20. For example, the positioning module 212 receives a satellite-broadcast positioning signal, and calculates its own position according to the positioning signal. The position may be, for example, represented by latitude, longitude, and altitude. An available satellite positioning system includes the Global Positioning System (GPS), Compass Navigation Satellite System (CNSS) or Global Navigation Satellite System (GLONASS). The positioning module 212 is not limited to using a satellite positioning technology. For example, the positioning module 212 may use a wireless positioning technology (e.g., a positioning technology based on a wireless base station or a wireless hotspot positioning technology). At this time, the positioning module 212 may be replaced with a corresponding module, or directly implemented by the processor 206 executing a particular positioning program.

The camera module 214 is used for capturing a photo or video. The captured photo or video may be stored in the memory 202, and may be sent through the radio frequency module 210. The camera module 214 may specifically include a lens module, an image sensor, a flash lamp, and other components. The lens module is used for imaging a photographed target, and mapping a resultant image to the image sensor. The image sensor is used for receiving light from the lens module to achieve sensitization, so as to record image information. Specifically, the image sensor may be implemented based on a Complementary Metal Oxide Semiconductor (CMOS), a Charge-Coupled Device (CCD) or other image sensing principles. The flash lamp is used for exposure compensation during photographing. Generally, the flash lamp for the client 20 may be a Light Emitting Diode (LED) flash lamp.

The audio module 216 provides an audio interface for a user, which may include one or more microphones, one or more loudspeakers and an audio circuit. The audio circuit receives sound data from the peripheral interface 208, converts the sound data to electrical information, and transmits the electrical information to the loudspeaker. The loudspeaker converts the electrical information to sound waves that can be heard by human ears. The audio circuit further receives electrical information from the microphone, converts an electrical signal to sound data, and transmits the sound data to the peripheral interface 208 for further processing. Audio data may be acquired from the memory 202 or through the radio frequency module 210. In addition, the audio data may also be stored in the memory 202 or sent through the radio frequency module 210. In some examples, the audio module 216 may further include an earphone jack, for providing an audio interface for a headset or other devices.

The touch screen 218 provides an output and input interface between the client 20 and the user at the same time. Specifically, the touch screen 218 displays video output for the user, and content of the video output may include texts, images, videos, or any combination thereof. Some output results correspond to user interface objects. The touch screen 218 further receives input of the user, such as gesture operations (e.g., click or sliding of a finger), so that the user interface objects respond to input of the user. The technology for detecting user input may be a resistive or capacitive touch detection technology or any other possible touch detection technology. A specific example of a display unit of the touch screen 218 includes, but is not limited to, a liquid crystal display or a light-emitting polymer display. In some other embodiments, the touch screen 218 may also be replaced with other types of display devices, such as a projection display device. Compared with general display panels, the projection display device further needs to include some members for projection, for example, a lens group.

The key module 220 also provides the user with an interface for input to the client 20, and the user can make the client 20 perform different functions by pressing different keys.

In some embodiments, the software program and module in the memory 202 includes: an operating system 224 and an application program 226. The operating system 224 may be, for example, any operating system applicable to a mobile terminal, such as Google's Android operating system, Apple's IOS operating system, Microsoft's Windows Mobile operating system or the like. The application program 226 runs over the operating system 224. In an example, the application program 226 may include a network communication application program, which provides the user with a function of sending texts, voice and videos to contacts. It can be understood that, the texts may be acquired by using the touch screen 218 or the key module 220, the voice may be input by using the audio module 216, and the video may be recorded in real time by using the camera module 214 and the audio module 216. After an input operation of the user triggers a predetermined sending operation, a data packet is sent to the application server 30 to complete the communication function, and a specific process thereof is as follows.

In FIG. 1, if a client intends to send a data packet to the application server 30, the data packet is first sent to a corresponding acceleration node, and then forwarded by the acceleration node. In the acceleration node, the transmission type of a current data packet is determined at first, and the data packet is forwarded by using corresponding processing logic according to different transmission types. The transmission type of the data packet is determined according to the corresponding relationship shown in the above table.

If the transmission type of the data packet is access, the data packet is forwarded according to logic corresponding to access. By using the client 11 as an example, a data packet thereof is sent to the acceleration node 21. Correspondingly, the acceleration node 21 receives the data packet sent by the client 11. According to the corresponding relationship of transmission types, the transmission type of the data packet in the acceleration node 21 is access.

In some embodiments, the acceleration node 21 acquires a session identifier (seq) according to the received data packet. In some embodiments, the session identifier is generated, for example, by the acceleration node 21 according to a connection request of the client 11, and is used for uniquely identifying a network session, and can be included in a data packet subsequently sent by the client 11. Certainly, the session identifier is not limited to being generated by the acceleration node 21, and may also be generated by a dedicated server, as long as uniqueness can be ensured. In some embodiments, the client 11 maintains a long connection with the acceleration node 21, and hold time of the long connection is duration of the network session, that is, effective time of the session identifier. After the long connection is disconnected, in some embodiments, a new session identifier is generated when the client 11 re-requests a connection to the acceleration node 21. Therefore, the same client 11 may use different session identifiers during different network sessions, but the different session identifiers can uniquely correspond to the client 11. In other words, the session identifier is used for uniquely identifying the user.

In some embodiments, the session identifier is directly obtained by parsing the data packet. In some other embodiments, the session identifier is indirectly acquired. For example, after establishing a network connection with the client 11, the acceleration node 21 stores a corresponding relationship between a network connection identifier and a session identifier. In this way, a corresponding session identifier can be acquired according to an identifier (Key) of a source network connection of the data packet. In some embodiments, in order to accelerate the search for a corresponding session identifier according to a network connection, the corresponding relationship between network connection identifiers and session identifiers is stored by using a hash table, and in this way, the corresponding session identifier can be found within the time complexity of O(1).

Then, the acceleration node 21 queries whether the corresponding user is an old user according to the acquired session identifier, that is, whether a user data packet that uses the session identifier has been forwarded. Specifically, the acceleration node 21 queries whether a state machine corresponding to the session identifier already exists.

In some embodiments, the acceleration node 21 stores a corresponding relationship between unique identifiers corresponding to user identities and state machines. For example, the corresponding relationship is stored by using a hash table, as shown in Table 2.

TABLE 2
Storage structure of user state machines

| | |
|---|---|
| Key[1] | State machine 1 |
| Key[2] | State machine 2 |
| . . . | . . . |
| Key[n − 1] | Empty |
| Key[n] | Empty |

In the case of search, a corresponding key of the hash table is calculated according to an acquired session identifier and a predetermined hash algorithm. In some embodiments, the corresponding key is specifically calculated according to the following formula: Key=hash(seq), and then a position corresponding to the key in the hash table is read. If a state machine already exists in the position, it is determined that a user data packet that uses the session identifier has been forwarded. If the position is empty, it is determined that no user data packet that uses the session identifier has been forwarded. By using Key[1] in Table 2 as an example, a state machine 1 is already stored, and thus, it is determined that a data packet having the same session has been forwarded. If the position corresponding to Key[n] is empty, it is determined that no data packet having the same session identifier has been forwarded.

If a corresponding state machine already exists, routing information used in previous sending is acquired from the state machine. In some embodiments, the routing information includes, for example, information identifying an acceleration node (for example, the acceleration node 22 or the acceleration node 25 shown in FIG. 1) to which the data packet is to be sent and/or a network connection through which the data packet is to be sent. The data packet is directly forwarded according to the acquired routing information.

If no corresponding state machine exists, it indicates that no user data packet that uses the session identifier has been forwarded. At this time, a corresponding state machine can be established for the session identifier, a route is assigned to the session identifier, the assigned route is stored in the corresponding state machine, and the data packet is forwarded by using the assigned route.

It can be understood that, route assigmnent mainly involves node selection and connection selection. By using the acceleration node 21 as an example, there are two options for its next node: the acceleration node 22 or the acceleration node 25. The acceleration node 21 may select an acceleration node randomly, or an acceleration node to be selected is calculated according to a predetermined algorithm, or an acceleration node is assigned by a dedicated management server. As stated above, a connection pool including a plurality of connections is maintained between the acceleration node 21 and the acceleration node 22 or the acceleration node 25. After the acceleration node is selected, one network connection may be randomly selected from the corresponding connection pool or selected according to a predetermined algorithm. So far, route assignment is completed.

In some embodiments, in the acceleration node 21, in order to facilitate transmission of a downlink data packet, a corresponding relationship between session identifiers and transmission types of data packets and a corresponding relationship between session identifiers and backward connection identifiers is stored. The relationships can be stored by using a hash table structure, so as to facilitate a search operation within the time complexity of O(1).

In some embodiments, a data packet from the client 11 is forwarded to the acceleration node 22 by the acceleration node 21. Correspondingly, the acceleration node 22 receives the data packet from the acceleration node 21.

Similar to the acceleration node 21, the acceleration node 22 may also determine the transmission type of the data packet. As shown in FIG. 1, a next-hop node of the acceleration node 22 may be the acceleration node 23 or the acceleration node 26. Therefore, in the acceleration node 22, the transmission type of the data packet from the acceleration node 21 is transmission. After the transmission type of the data packet is acquired, the acceleration node 22 forwards the data packet by using logic corresponding to the transmission type. Specific details are as follows.

It can be understood that, data packets transmitted in each network connection in the connection pool between the acceleration node 21 and the acceleration node 22 may be correspondingly used for a plurality of session identifiers, that is, the transmitted data packets are from different clients. When the transmission type is transmission, the acceleration node 22 may not care about which session identifier a data packet in a certain network connection specifically corresponds to, and the acceleration node 22 only needs to forward the data packet to a next-hop node. For example, when the transmission type is transmission, the acceleration node 22 forwards the data packet to a next-hop node regardless of a session identifier the data packet corresponds to. When the transmission type is transmission, the acceleration node 22 may use one or more network connections as a unit, select a route for the data packet, and transmit the data packet.

In some embodiments, the acceleration node 22 stores a backward connection identifier (BC_Key) and a corresponding state machine. Specifically, the backward connection identifier and the corresponding state machine may be stored by using a hash table structure, as shown in the following Table 3.

TABLE 3
Storage structure of connection state machines

| | |
|---|---|
| BC_Key[1] | State machine 1 |
| BC_Key[2] | State machine 2 |
| . . . | . . . |
| BC_Key[n − 1] | Empty |
| BC_Key[n] | Empty |

After a data packet is received from a backward network connection, a corresponding state machine is searched for according to an identifier of the backward network connection. Specifically, a corresponding position in the hash table is read according to the identifier of the backward network connection, and if a state machine already exists in the position, a route has been assigned to the backward network connection. If the position is empty, no route has been assigned to the backward network connection.

If a corresponding state machine exists, the data packet is forwarded according to routing information stored in the state machine. If no corresponding state machine exists, a corresponding state machine is established for the identifier of the backward network connection, a route is assigned thereto, the assigned route is stored in the state machine, and the data packet is forwarded according to the assigned route. The process of route assignment is similar to that in the acceleration node 21, and reference can be made thereto.

In some cases, a data packet from the acceleration node 21 is forwarded to the acceleration node 23 by the acceleration node 22. Correspondingly, the acceleration node 23 receives the data packet from the acceleration node 21.

Similar to the acceleration node 21, the acceleration node 23 may also determine the transmission type of the data packet first. As shown in FIG. 1, a next-hop node of the acceleration node 23 can only be the application server 30. Therefore, in the acceleration node 23, the transmission type of the data packet from the acceleration node 22 is session. After the transmission type of the data packet is acquired (or determined), the acceleration node 23 forwards the data packet by using logic corresponding to the transmission type. Specific details are as follows.

The acceleration node 23 stores a corresponding relationship between session identifiers and state machines. For example, the corresponding relationship may be stored by using a hash table, and a storage structure thereof may be similar to Table 2.

In the case of search, a corresponding key of the hash table is calculated according to a session identifier (seq) included in the data packet and a predetermined hash algorithm. In some embodiments, the corresponding key is specifically calculated according to the following formula: Key=hash(seq), and then a position corresponding to the key in the hash table is read.

If a corresponding state machine already exists, routing information used in previous sending is acquired from the state machine. In some embodiments, the routing information includes, for example, information indicating a network connection through which the data packet is to be sent. The data packet is then directly forwarded according to the acquired routing information.

If no corresponding state machine exists, it indicates that no user data packet that uses the session identifier has been forwarded. At this time, a corresponding state machine can be established for the session identifier, a route is assigned to the session identifier, the assigned route is stored in the corresponding state machine, and the data packet is forwarded by using the assigned route.

The next-hop node of the acceleration node 23 can only be the application server 30. In some embodiments, route assignment herein includes connection selection only, which can be one connection selected from the connection pool for the session identifier to forward the data packet.

Through the above process, the data packet is forwarded to the application server 30 from the client 11, and the transmission types thereof in the acceleration node 21, the acceleration node 22, and the acceleration node 23 are access, transmission and session respectively. However, it can be understood that not all data packets go through these transmission types.

For example, for a data packet from the client 13, the transmission type thereof in the acceleration node 25 is access, the transmission type thereof in the acceleration node 26 is session, and the data packet does not have the transmission type of “transmission.” A data packet from the client 14 only passes through the acceleration node 26, and the transmission type thereof in the acceleration node 26 is access+session.

The transmission process of an uplink data packet (a data packet from a client to an application server) is described above, and the following describes a transmission process of a downlink data packet (a data packet from the application server to the client).

In some embodiments, for the application server 30, the data packet adopts a policy of returning by using the original connection (or route). For example, a response data packet from the application server 30 to the client 11 may be first sent to the acceleration node 23 (when a data packet was first sent from the client 11 to the application server 30 through the acceleration node 23).

After receiving the response data packet sent by the application server 30, the acceleration node 23 determines the transmission type of the response data packet. Specifically, the acceleration node 23 obtains a session identifier (seq) by parsing the response data packet. The corresponding data packet transmission type is then searched for. In the acceleration node 23, the transmission type of the response data packet to the client 11 should be session. Correspondingly, the acceleration node 23 forwards the data packet according to the transmission type.

For an uplink data packet and a downlink data packet having the same session identifier, exactly the same path may be used, that is, the uplink data packet and downlink data packet are forwarded through the same node and the same network connection. The uplink data packet and downlink data packet may be sent only through the same node, but are not limited to being forwarded by using the same network connection. For example, the uplink data packet and downlink data packet may also be forwarded by using different paths, as long as it is ensured that the downlink data packet can be returned to an acceleration node directly connected to the client.

In the following, exactly the same path being used is used as an example for description. At times, it is necessary to update a reverse route correspondingly after forward transmission of a data packet. For example, in the acceleration node 23, the transmission type of a data packet from the acceleration node 22 is session. In addition to storing a corresponding relationship between the session identifier and the transmission type, after the data packet is forwarded to the application server 30, reverse routing information may be updated, for example, a corresponding relationship of a previous node (that is, a source node of the data packet) and a source connection (backward connection) identifier are stored in a state machine corresponding to the session identifier.

In this case, in the acceleration node 23, a corresponding state machine can be searched for according to the session identifier, and the stored previous node and the backward connection identifier are acquired from the state machine. Afterwards, a response data packet is forwarded to the previous node, that is, the acceleration node 22, through a backward network connection corresponding to the backward connection identifier.

If it is not required that the downlink data packet and the uplink data packet use the same network connection, after sending a data packet to the application server 30, the acceleration node 23 does not need to store a source connection identifier of the uplink data packet in a state machine corresponding to the session identifier. In this case, during transmission of a downlink data packet, the application server 30 only needs to randomly select a network connection to send the downlink data packet to the previous node.

After receiving the data packet sent by the acceleration node 23, the acceleration node 22 determines the transmission type of the response data packet. Specifically, the acceleration node 22 obtains a session identifier (seq) by parsing the response data packet, and then searches for the corresponding data packet transmission type. In the acceleration node 22, the transmission type of the response data packet to the client 11 should be transmission. Correspondingly, the acceleration node 22 forwards the data packet according to the transmission type.

During transmission of the uplink data packet, after the acceleration node 22 sends the data packet to the acceleration node 23, a reverse route may be updated, that is, a corresponding relationship between the session identifier and the previous node (the source node of the data packet) and a corresponding relationship between the session identifier and identifier of the source connection (backward connection) are stored separately. In this manner, for the downlink data packet, the acceleration node 22 may acquire the session identifier from the response data packet, and then searches for the corresponding previous node and the source connection identifier according to the session identifier. The data packet is then forwarded through the source connection. The response data packet to the client 11 may be forwarded to the acceleration node 21.

After receiving the data packet sent by the acceleration node 22, the acceleration node 21 determines the transmission type of the response data packet. Specifically, the acceleration node 21 obtains a session identifier (seq) by parsing the response data packet, and then searches for the corresponding data packet transmission type. In the acceleration node 21, the transmission type of the response data packet to the client 11 should be access. Correspondingly, the acceleration node 21 forwards the data packet according to the transmission type.

As stated above, a corresponding relationship between the session identifier and the network connection identifier may be stored in the acceleration node 21, a corresponding network connection can be identified according to the session identifier, and then the data packet can be forwarded to the client 11 through the identified network connection.

The transmission process of a downlink data packet is described above. However, it can be understood that, some downlink data packets can reach the client without going through all the transmission types. That is, a downlink data packet to the client 13 may only go through two transmission types: session and access. A downlink data packet to the client 14 only passes through the acceleration node 26, and the transmission process thereof is similar to that of the downlink data packet to the client 11 in the acceleration node 21.

In the above transmission process, if various corresponding relationships are all stored by using a hash table structure, time complexity of each operation is O(1), and the total time complexity is also O(1).

According to the above transmission process, both uplink data packets and downlink data packets can be transmitted efficiently by using the data transmission system in FIG. 1, which can increase the access connection capability of a single machine.

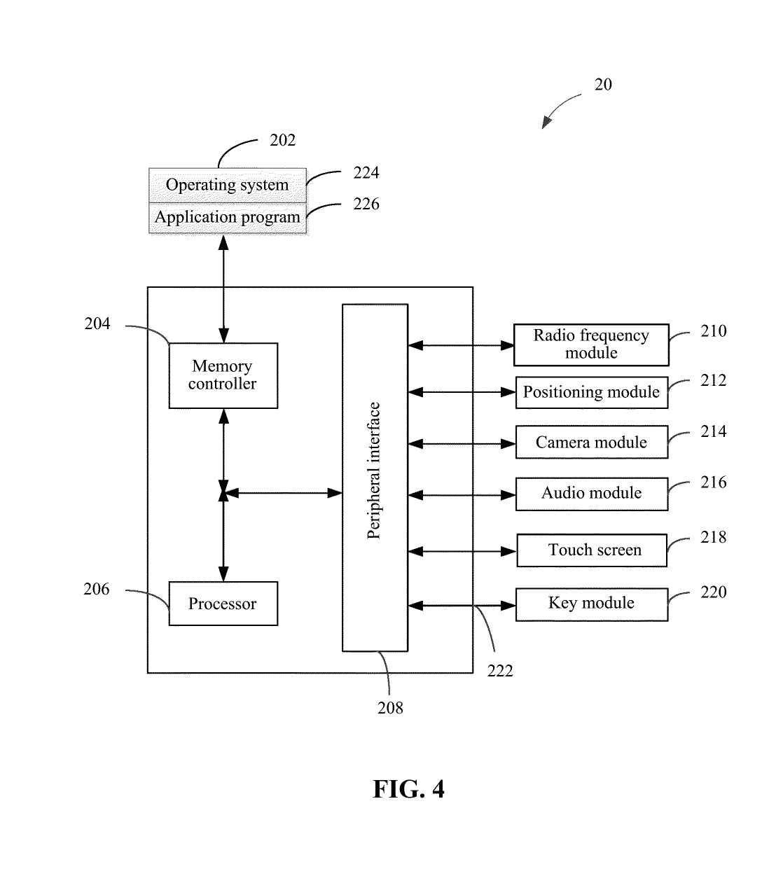

FIG. 5 is a flowchart of a method for transmitting data in a network system in accordance with some embodiments. The method illustrated in FIG. 5 can be applied to various acceleration nodes shown in FIG. 1. The method illustrated in FIG. 5 includes the following steps.

Step S201. Receive, at a first acceleration node through a first network connection, a first data packet sent by the client.

Referring to FIG. 1, the first acceleration node may be, for example, the acceleration node 25, which is directly connected with the client 13. When the client 13 intends to send a data packet to the application server 30, the data packet is first sent to the acceleration node 25, and correspondingly, the acceleration node 25 receives the data packet from the client 13.

Step S202. Acquire a first session identifier for uniquely identifying a user according to the first data packet.

In some embodiments, the acceleration node 25 generates a session identifier for the client 13 when the client 13 initiates a connection request for the first time. As long as the network connection between the client 13 and the acceleration node 25 is still maintained, session identifiers can be used to distinguish different clients. For example, the session identifier is included in each data packet sent by the client 13 to the acceleration node 25. Therefore, the acceleration node 25 only needs to parse the header of a data packet after receiving the data packet, to obtain the corresponding session identifier.

Step S203. Determine a transmission type of the first data packet in the first acceleration node according to a position of the first acceleration node in the network system.

As the first data packet is from the client, the first data packet has different transmission types depending on different types of target nodes. When the target node is an acceleration node, the transmission type of the first data packet in the first acceleration node is access; when the target node is an application server, the transmission type of the first data packet in the first acceleration node is access+session.

Step S204. Acquire a second network connection from a connection pool between the first acceleration node and a target node of the first data packet according to the first session identifier.

The target node of the first data packet is the application server or another acceleration node, which is different from the first acceleration node, in the multiple acceleration nodes. For example, in FIG. 1, the target node of the first data packet may be the acceleration node 23 or the acceleration node 26. In other embodiments, the acceleration node 25 may also be directly connected with the application server 30, and in this case, the target node of the first data packet may also be the application server 30.

Specifically, step S204 may include the following steps: calculating a first index value by using a predetermined hash algorithm according to the first session identifier; searching, according to the first index value, for a corresponding record in a hash table where a corresponding relationship between the first session identifier and the second network connection is stored; if the corresponding record is not empty, parsing the corresponding record to obtain an identifier of the second network connection; and if the corresponding record is empty, selecting one network connection from the connection pool between the first acceleration node and the target node of the first data packet as the second network connection.

Step S205. Send the first data packet to the target node of the first data packet through the second network connection.

After the second network connection is acquired, the first data packet can be sent to the target node of the first data packet, for example, the acceleration node 26 or the application server 30, through the acquired second network connection.

Step S206. Separately store corresponding relationships between the first session identifier and the transmission type of the first data packet, between the first session identifier and an identifier of the first network connection, and between the first session identifier and an identifier of the second network connection.

In some embodiments, the corresponding relationships are stored in a key-value format. Preferably, a storage structure with search algorithm time complexity not exceeding O(1) can be used.

For example, the corresponding relationships may be stored by using hash tables, and one hash table is established for each corresponding relationship. By using the corresponding relationship between the first session identifier and the transmission type of the first data packet as an example, for each key-value pair of <first session identifier, transmission type of the first data packet>, the first session identifier is mapped to a first index value by using a predetermined hash algorithm, so as to obtain a key-value pair of <first index value, transmission type of the first data packet>. Then, the key-value pair is stored in the hash table.

After the above storage process, the information can be found while the first session identifier does not exceed the time complexity of O(1), and is used in the subsequent data transmission process, to improve data transmission efficiency.

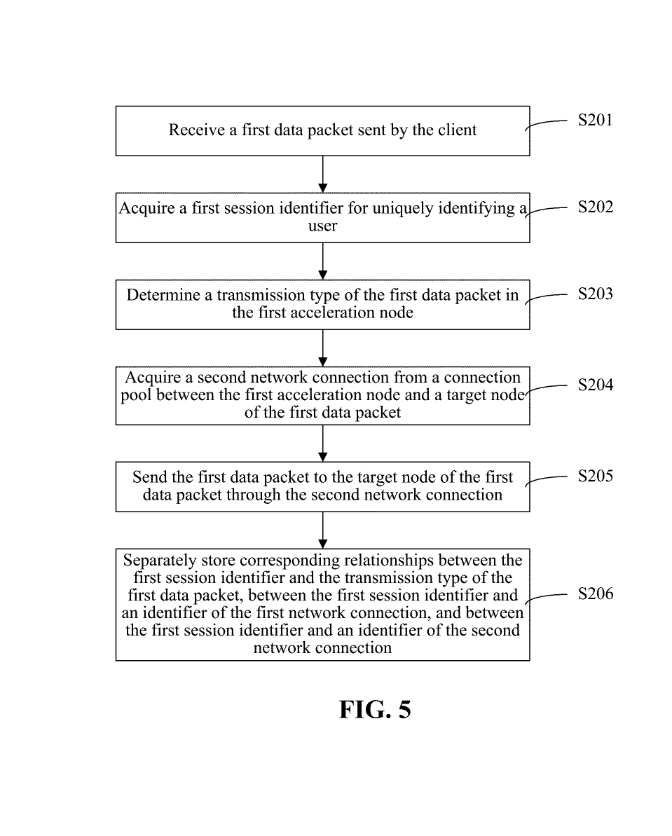

FIG. 6 is a flowchart of a method for transmitting data in a network system in accordance with some embodiments. The method illustrated in FIG. 6 can be applied to various acceleration nodes shown in FIG. 1. The method illustrated in FIG. 6 includes the following steps.

Step S301. Receive, at the first acceleration node through a third network connection, a second data packet sent by a second acceleration node.

Referring to FIG. 1, the first acceleration node may be, for example, the acceleration node 25, and the second acceleration node may be, for example, the acceleration node 24; therefore, according to a transmission flow direction of the data packet, the first acceleration node (the acceleration node 25) is located between the second acceleration node (the acceleration node 24) and the application server 30.

Step S302. Determine a transmission type of the second data packet in the first acceleration node according to a position of the first acceleration node in the network system.

As the type of the source node of the second data packet is acceleration node, and the type of the target node is application server, the transmission type of the second data packet in the first acceleration node is session.

Step S303. Acquire, according to the second data packet, a second session identifier for uniquely identifying a user.

The acceleration node 25 may parse the header of the second data packet after receiving the second data packet, to obtain the second session identifier.

Step S304. Acquire a fourth network connection from a connection pool between the first acceleration node and the application server according to the second session identifier.

As shown in FIG. 1, a connection pool is maintained between the acceleration node 25 and the application server 30, and includes a plurality of TCP connections of a long connection type.

For example, step S304 may include: calculating a second index value by using a predetermined hash algorithm according to the second session identifier; searching, according to the second index value, for a corresponding record in a hash table where a corresponding relationship between the second session identifier and the fourth network connection is stored; if the corresponding record is not empty, parsing the corresponding record to obtain an identifier of the fourth network connection; and if the corresponding record is empty, selecting one network connection from the connection pool between the first acceleration node and the application server as the fourth network connection.

Step S305. Send the second data packet to the application server through the fourth network connection.

After the fourth network connection is acquired, the second data packet can be sent to the application server 30 through the acquired fourth network connection.

Step S306. Separately store corresponding relationships between the second session identifier and the transmission type of the second data packet and between the second session identifier and an identifier of the third network connection, and store a corresponding relationship between the second session identifier and an identifier of the fourth network connection.

Similar to the manner described in the first embodiment, the corresponding relationships may all be stored in a key-value storage manner. Preferably, a storage structure with search algorithm time complexity not exceeding O(1) can be used (e.g., a hash table can be used).

According to the method illustrated in FIG. 6, routing information can be found while the first session identifier does not exceed the time complexity of O(1), and is used in the subsequent data transmission process, to improve data transmission efficiency.

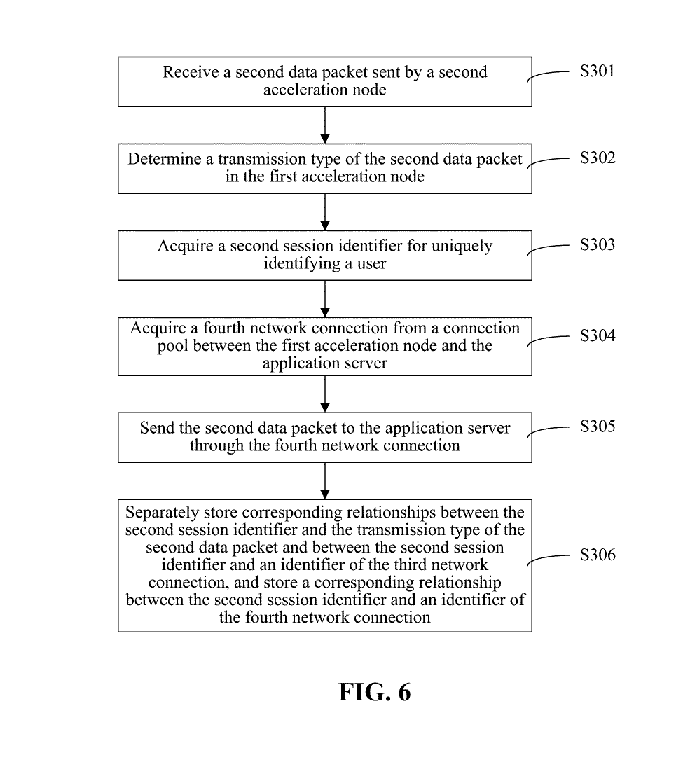

FIG. 7 is a flowchart of a method for transmitting data in a network system in accordance with some embodiments. The method illustrated in FIG. 7 can be applied to various acceleration nodes shown in FIG. 1. The method illustrated in FIG. 7 includes the following steps.

Step S401. Receive, at the first acceleration node through a fifth network connection, a third data packet sent by a third acceleration node.

Referring to FIG. 1, the first acceleration node may be, for example, the acceleration node 25, the third acceleration node may be, for example, the acceleration node 21, and the fourth acceleration node may be, for example, the acceleration node 26. Therefore, according to a transmission flow direction of the data packet, the first acceleration node (the acceleration node 25) is located between the third acceleration node (the acceleration node 21) and the fourth acceleration node (the acceleration node 26). The fourth acceleration node is located between the first acceleration node and the application server 30.

Step S402. Determine a transmission type of the third data packet in the first acceleration node according to a position of the first acceleration node in the network system.

As the type of the source node of the third data packet and the type of the target node thereof are acceleration node, the transmission type of the third data packet in the first acceleration node is transmission.

Step S403. Acquire, according to the third data packet, a third session identifier for uniquely identifying a user.

The first acceleration node may parse the header of the third data packet after receiving the third data packet, to obtain the third session identifier.

Step S404. Acquire a sixth network connection from a connection pool between the first acceleration node and the fourth acceleration node according to an identifier of the fifth network connection.

As shown in FIG. 1, a connection pool is maintained between the first acceleration node (the acceleration node 25) and the fourth acceleration node (the acceleration node 26), and includes a plurality of TCP connections of a long connection type.

For example, step S404 may include the following steps: searching, according to the identifier of the fifth network connection, for a corresponding record in a hash table where a corresponding relationship between the identifier of the fifth network connection and an identifier of the sixth network connection is stored; if the corresponding record is not empty, parsing the corresponding record to obtain the identifier of the sixth network connection; and if the corresponding record is empty, selecting one network connection from the connection pool between the first acceleration node and the fourth acceleration node as the sixth network connection.

Step S405. Send the third data packet to the fourth acceleration node through the sixth network connection.

After the sixth network connection is acquired, the third data packet can be sent to the target node of the third data packet, i.e., the acceleration node 26, through the acquired sixth network connection.

Step S406. Separately store corresponding relationships between the third session identifier and the transmission type of the third data packet and between the third session identifier and an identifier of the third acceleration node, and store a corresponding relationship between the identifier of the fifth network connection and an identifier of the sixth network connection.

After the above storage process, the information can be found while the first session identifier does not exceed the time complexity of O(1), and is used in the subsequent data transmission process, to improve data transmission efficiency.

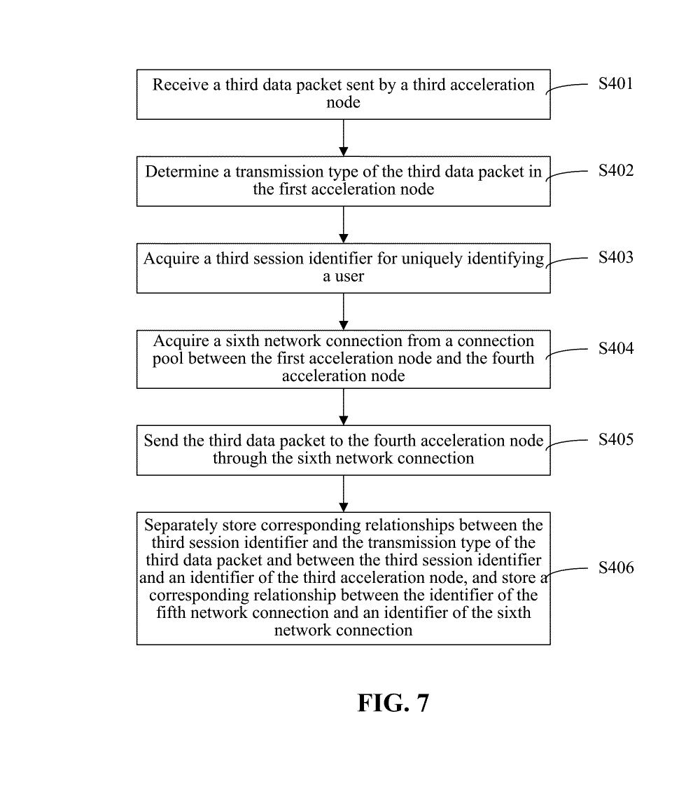

FIG. 8 is a flowchart of a method for transmitting data in a network system in accordance with some embodiments. The method illustrated in FIG. 8 can be applied to various acceleration nodes shown in FIG. 1. As shown in FIG. 8, the method illustrated in FIG. 8 is similar to that shown in FIG. 6, and the difference lies in that, after step S306, the method illustrated in FIG. 8 further includes the following steps.

Step S501. Receive, at the first acceleration node through the fourth network connection, a first response data packet sent by the application server.

After step S305, the second data packet is sent to the application server 30, and the application server 30 performs corresponding data processing after receiving the second data packet, for example, forwards the second data packet to another user, generates a first response data packet according to data fed back by the another user, and sends the first response data packet to the first acceleration node (that is, the acceleration node 25) through the fourth network connection.

Step S502. Acquire the third network connection according to the second session identifier included in the first response data packet.

Specifically, the first acceleration node parses the header of the first response data packet to obtain the second session identifier, maps the second session identifier to an index value by using a predetermined hash algorithm, then reads a record corresponding to the index value from a hash table where the second session identifier and the third network connection are stored, and parses the read record to obtain an identifier of the third network connection.

Step S503. Send the first response data packet to the second acceleration node through the third network connection.

After the identifier of the third network connection is obtained by means of parsing, the third network connection is acquired according to the identifier, and the first response data packet is sent to the second acceleration node (that is, the acceleration node 24) through the third network connection.

According to the method illustrated in FIG. 8, fast forwarding of the response data packet can be implemented, and data transmission efficiency can be improved.

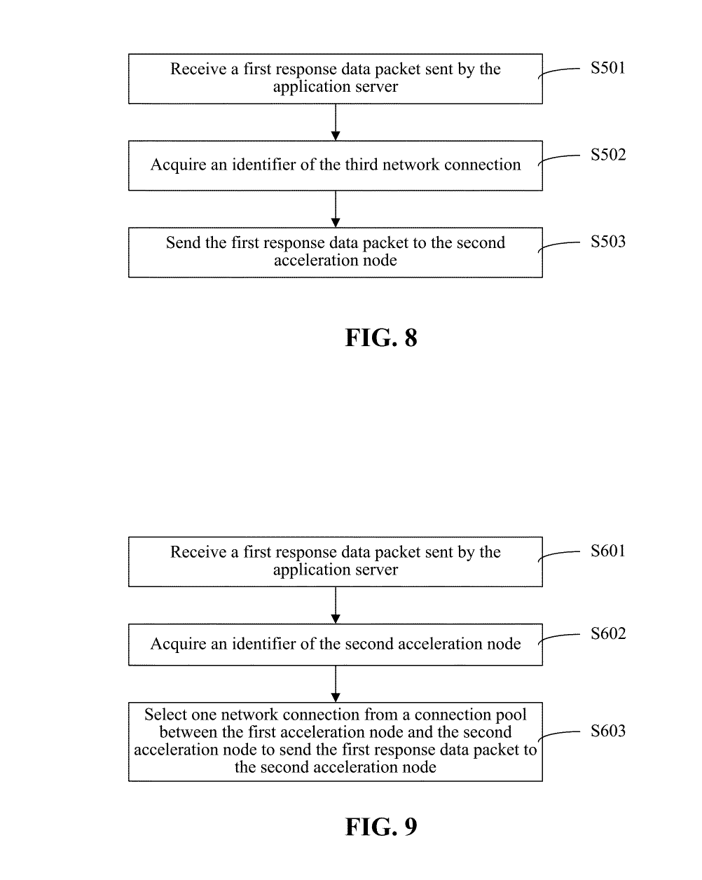

FIG. 9 is a flowchart of a method for transmitting data in a network system in accordance with some embodiments. The method illustrated in FIG. 9 can be applied to various acceleration nodes shown in FIG. 1. As shown in FIG. 9, the method illustrated in FIG. 9 is similar to that in FIG. 6, and the difference lies in that, after step S306, the method illustrated in FIG. 9 further includes the following steps.

Step S601. Receive, at the first acceleration node, a first response data packet sent by the application server through the fourth network connection.

After step S305, the second data packet is sent to the application server 30, and the application server 30 performs corresponding data processing after receiving the second data packet, for example, forwards the second data packet to another user, generates a first response data packet according to data fed back by the another user, and sends the first response data packet to the first acceleration node (that is, the acceleration node 25) through the fourth network connection.

Step S602. Acquire an identifier of the second acceleration node according to the second session identifier included in the first response data packet.

Specifically, the first acceleration node parses the header of the first response data packet to obtain the second session identifier, maps the second session identifier to an index value by using a predetermined hash algorithm, then reads a record corresponding to the index value from a hash table where the second session identifier and an identifier of the second acceleration node are stored, and parses the read record to obtain the identifier of the second acceleration node.

Step S603. Select one network connection from a connection pool between the first acceleration node and the second acceleration node to send the first response data packet to the second acceleration node.

Compared with the method illustrated in FIG. 8, it is not limited in the method illustrated in FIG. 9 that the downlink data packet should be returned through the same connection as the uplink data packet. Therefore, even if the network connection, which is originally used for transmitting the uplink data packet, in the connection pool is disconnected, transmission of the downlink data packet is not affected, and such a manner improves reliability of data transmission.

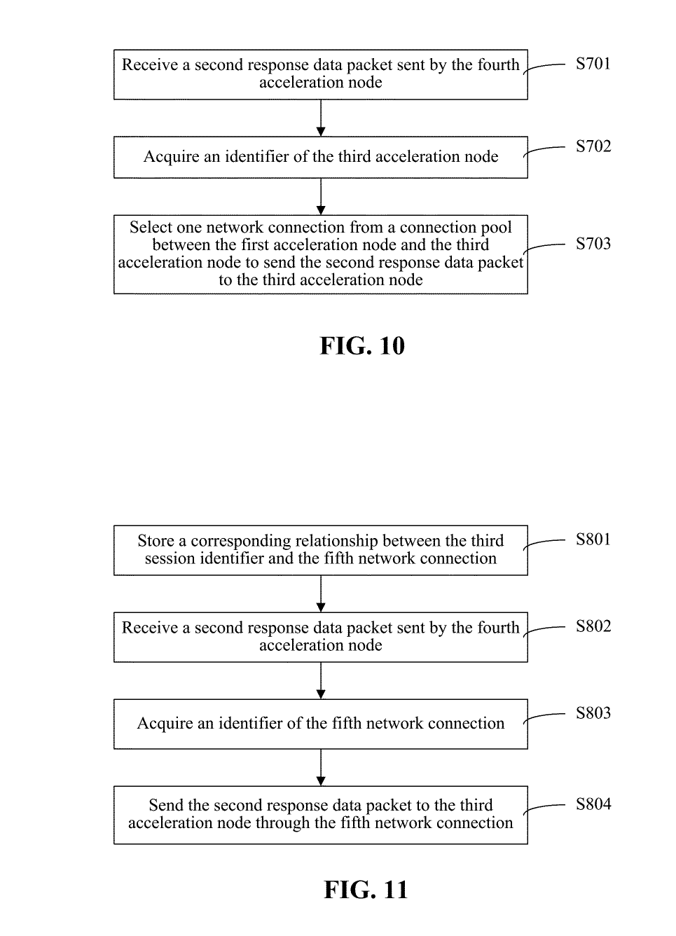

FIG. 10 is a flowchart of a method for transmitting data in a network system in accordance with some embodiments. The method illustrated in FIG. 10 can be applied to various acceleration nodes shown in FIG. 1. As shown in FIG. 10, the method illustrated in FIG. 10 is similar to that in FIG. 7, and the difference lies in that, after step S406, the method illustrated in FIG. 10 further includes the following steps.

Step S701. Receive a second response data packet sent by the fourth acceleration node through the sixth network connection at the first acceleration node.

After step S405, the third data packet is sent to the fourth acceleration node. It can be understood that, the third data packet is finally forwarded to the application server 30, and the application server 30 performs corresponding data processing after receiving the third data packet, for example, forwards the third data packet to another user, and generates a second response data packet according to data fed back by the another user; the response data packet may be first forwarded to the fourth acceleration node. However, the fourth acceleration node may forward the response data packet to the first acceleration node through the sixth network connection.

Step S702. Acquire an identifier of the third acceleration node according to the third session identifier included in the second response data packet.

Specifically, the first acceleration node parses the header of the second response data packet to obtain the third session identifier, maps the third session identifier to an index value by using a predetermined hash algorithm, then reads a record corresponding to the index value from a hash table where the third session identifier and an identifier of the third acceleration node are stored, and parses the read record to obtain the identifier of the third acceleration node.

Step S703. Select one network connection from a connection pool between the first acceleration node and the third acceleration node to send the second response data packet to the third acceleration node.

A network connection may be randomly selected from the connection pool between the first acceleration node and the third acceleration node, or selected according to a predetermined rule or algorithm.

According to the method illustrated in FIG. 10, the second response data packet can be fast forwarded to the third acceleration node, and is not affected by whether a connection originally for transmitting a data packet from the third acceleration node to the first acceleration node is disconnected.

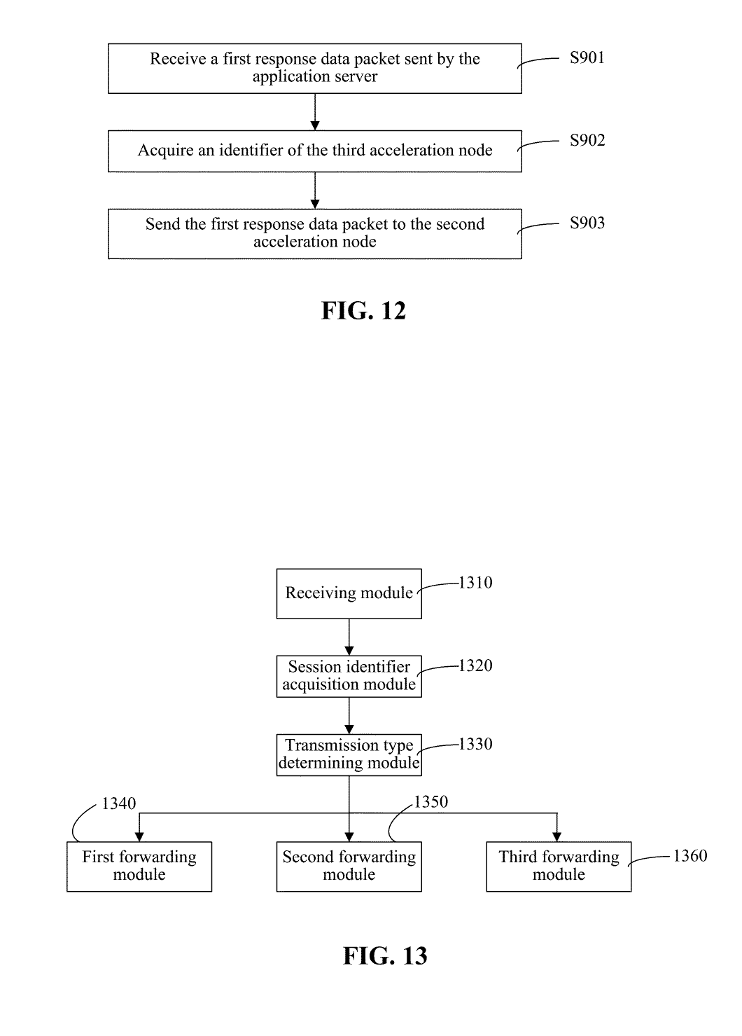

FIG. 11 is a flowchart of a method for transmitting data in a network system in accordance with some embodiments. The method illustrated in FIG. 11 can be applied to various acceleration nodes shown in FIG. 1. As shown in FIG. 11, the method illustrated in FIG. 11 is similar to that in FIG. 7, and the difference lies in that, after step S405, the method illustrated in FIG. 7 further includes the following steps.

Step S801. Store a corresponding relationship between the third session identifier and the fifth network connection.

For example, after the third data packet is sent, a key-value pair of <index value, identifier of the fifth network connection> is first generated according to a key-value of <third session identifier, identifier of the fifth network connection>. The index value is calculated according to the third session identifier and a predetermined hash algorithm.

Step S802. Receive, at the first acceleration node, a second response data packet sent by the fourth acceleration node through the sixth network connection.

After step S405, the third data packet is sent to the fourth acceleration node; it can be understood that, the third data packet is finally forwarded to the application server 30, and the application server 30 performs corresponding data processing after receiving the third data packet, for example, forwards the third data packet to another user, and generates a second response data packet according to data fed back by the another user; the response data packet may be first forwarded to the fourth acceleration node. However, the fourth acceleration node may forward the response data packet to the first acceleration node through the sixth network connection.

Step S803. Acquire an identifier of the fifth network connection according to the third session identifier included in the second response data packet.

Specifically, the first acceleration node parses the header of the second response data packet to obtain the third session identifier, maps the third session identifier to an index value according to a predetermined hash algorithm, then reads a record corresponding to the index value from a hash table where the third session identifier and an identifier of the fifth network connection are stored, and parses the read record to obtain the identifier of the fifth network connection.

Step S804. Send the second response data packet to the third acceleration node through the fifth network connection.

The fifth network connection is acquired according the identifier of the fifth network connection obtained by means of parsing, and then the second response data packet is sent to the third acceleration node through the acquired fifth network connection.

According to the method illustrated in FIG. 11, the second response data packet is returned to the previous node from a connection identical with that of the uplink data packet.

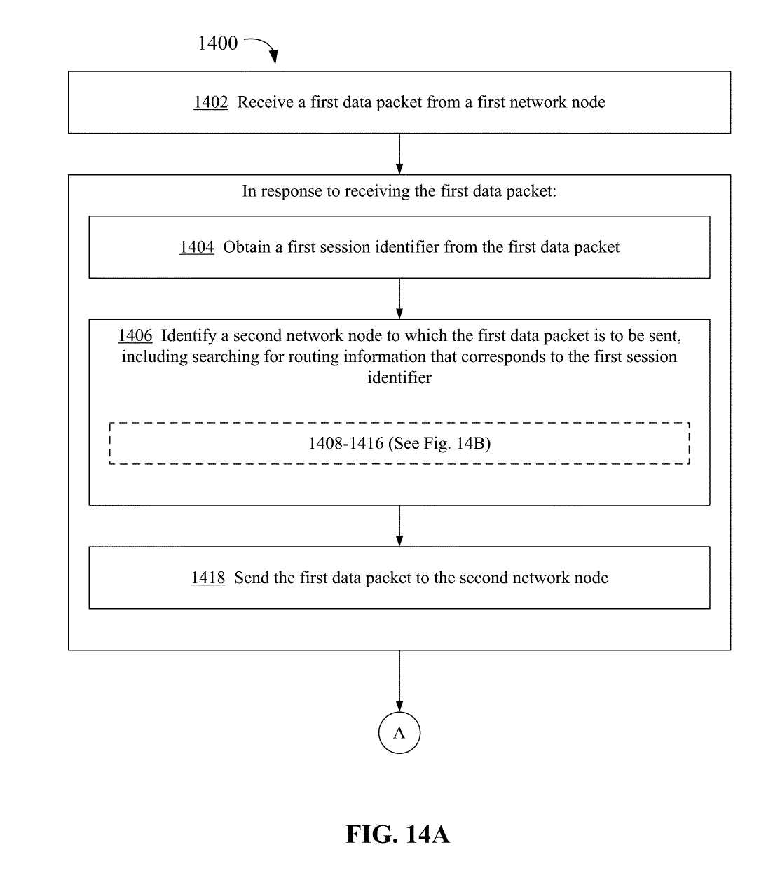

FIG. 12 is a flowchart of a method for transmitting data in a network system in accordance with some embodiments. The method illustrated in FIG. 12 can be applied to various acceleration nodes shown in FIG. 1. The method illustrated in FIG. 12 is similar to that in FIG. 5, and the difference lies in that, after step S205, the method illustrated in FIG. 12 further includes the following steps.

Step S901. Receive, at the first acceleration node, a third response data packet sent by the target node of the first data packet through the second network connection.

After step S205, the first data packet is sent to the target node, and the target node may be another acceleration node, and may also be the application server 30. It can be understood that, even if the first data packet is sent to another acceleration node, the first data packet is finally forwarded to the application server 30, and the application server 30 performs corresponding data processing, for example, forwards the first data packet to another user. The application server 30 may further generate a third response data packet, and forward the third response data packet to the target node of the first data packet. Afterwards, the target node of the first data packet sends the third response data packet to the first acceleration node through the second network connection.

Step S902. Acquire an identifier of the first network connection according to the first session identifier included in the third response data packet.

Specifically, the first acceleration node parses the header of the third response data packet to obtain the first session identifier, maps the first session identifier to an index value by using a predetermined hash algorithm, then reads a record corresponding to the index value from a hash table where the first session identifier and the first network connection are stored, and parses the read record to obtain the identifier of the first network connection.

Step S903. Send the third response data packet to the client through the first network connection.

After the identifier of the first network connection is obtained by means of parsing, the first network connection is acquired according to the identifier, and the third response data packet is sent to the client 13 through the first network connection.

According to the method illustrated in FIG. 12, fast forwarding of the response data packet can be implemented, and data transmission efficiency can be improved.

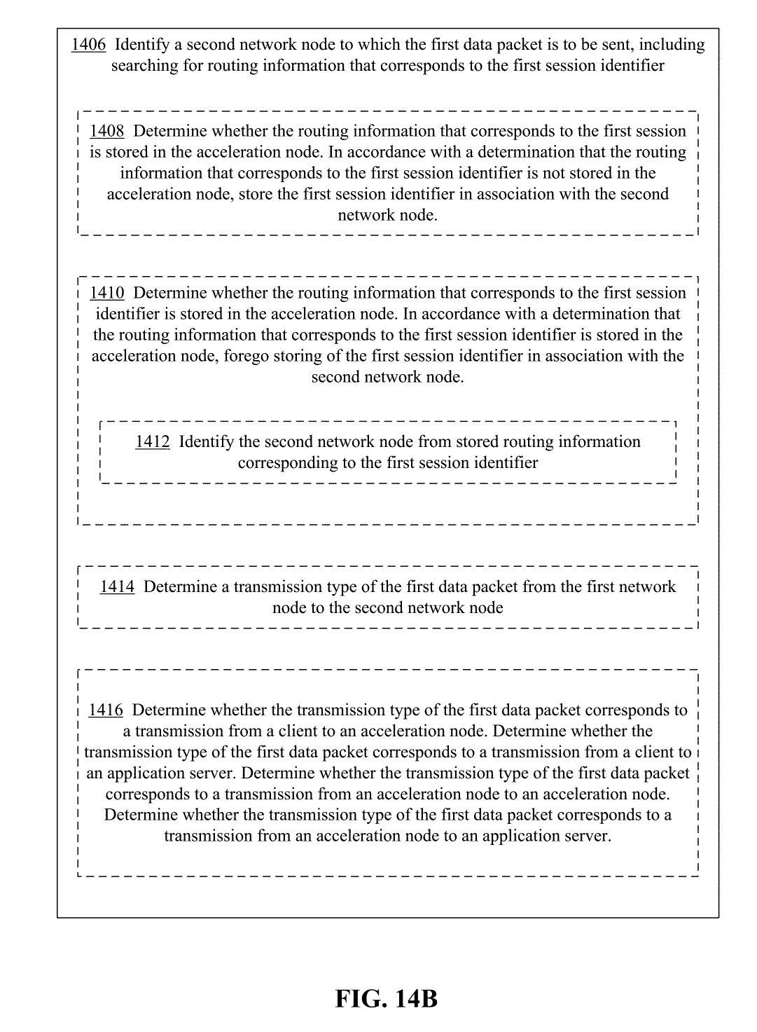

FIG. 13 is a structural block diagram of an apparatus for transmitting data in a network system in accordance with some embodiments. The application shown in FIG. 13 can be applied to various acceleration nodes shown in FIG. 1. The apparatus in FIG. 13 includes: a receiving module 1310, a session identifier acquisition module 1320, a transmission type determining module 1330, a first forwarding module 1340, a second forwarding module 1350, and a third forwarding module 1360.

The receiving module 1310 may be used for receiving, at a first acceleration node through a first network connection, a first data packet sent by the client, where the first acceleration node is an acceleration node that is directly connected with the client, in the multiple acceleration nodes. The session identifier acquisition module 1320 is used for acquiring, according to the first data packet, a first session identifier for uniquely identifying a user.

The receiving module 1310 may be further used for receiving, at the first acceleration node through a third network connection, a second data packet sent by a second acceleration node, where the first acceleration node is located between the second acceleration node and the application server.

The receiving module 1310 may be further used for receiving, at the first acceleration node through a fifth network connection, a third data packet sent by a third acceleration node, where the first acceleration node is located between the third acceleration node and a fourth acceleration node, and the fourth acceleration node is located between the first acceleration node and the application server.

The receiving module 1310 may be further used for receiving, at the first acceleration node through the fourth network connection, a first response data packet sent by the application server.

The receiving module 1310 may be further used for receiving, at the first acceleration node through the sixth network connection, a second response data packet sent by the fourth acceleration node.

The receiving module 1310 may be further used for receiving, at the first acceleration node through the second network connection, a third response data packet sent by the target node of the first data packet.

The session identifier acquisition module 1320 is used for acquiring a corresponding session identifier from a data packet. Specifically, the session identifier acquisition module 1320 may parse the header of the data packet to obtain the corresponding session identifier.

The transmission type determining module 1330 is used for determining a transmission type of the first data packet, the second data packet, the third data packet, the first response data packet, the second response data packet, or the third response data packet in the first acceleration node according to a position of the first acceleration node in the network system.

It can be understood that, the first data packet, the second data packet, and the third data packet have different transmission types; the first response data packet, the second response data packet, and the third response data packet also have different transmission types.

According to different transmission types, the transmission type determining module 1330 may further call corresponding forwarding modules. For example, if the transmission type is access or access+session, the transmission type determining module 1330 calls the first forwarding module 1340; if the transmission type is session, the transmission type determining module 1330 calls the second forwarding module 1350; or if the transmission type is transmission, the transmission type determining module 1330 calls the third forwarding module 1360.

The first forwarding module 1340 is used for performing the following operations: acquiring a second network connection from a connection pool between the first acceleration node and a target node of the first data packet according to the first session identifier, where the target node of the first data packet is the application server or another acceleration node, which is different from the first acceleration node, in the multiple acceleration nodes; sending the first data packet to the target node of the first data packet through the second network connection; and separately storing corresponding relationships between the first session identifier and the transmission type of the first data packet, between the first session identifier and an identifier of the first network connection, and between the first session identifier and an identifier of the second network connection.

Further, the first forwarding module 1340 is used for: acquiring the identifier of the first network connection according to the first session identifier included in the third response data packet; and sending the third response data packet to the client through the first network connection.

The second forwarding module 1350 is used for performing the following operations: acquiring a fourth network connection from a connection pool between the first acceleration node and the application server according to the second session identifier; sending the second data packet to the application server through the fourth network connection; and separately storing corresponding relationships between the second session identifier and the transmission type of the second data packet and between the second session identifier and an identifier of the third network connection, and storing a corresponding relationship between the second session identifier and an identifier of the fourth network connection.

Further, the second forwarding module 1350 is used for: acquiring the third network connection according to the second session identifier included in the first response data packet; and sending the first response data packet to the second acceleration node through the third network connection. Alternatively, the second forwarding module 50 is further used for: acquiring an identifier of the second acceleration node according to the second session identifier included in the first response data packet; selecting one network connection from a connection pool between the first acceleration node and the second acceleration node; and sending the first response data packet to the second acceleration node through the selected network connection.

The third forwarding module 1360 is used for performing the following operations: acquiring a sixth network connection from a connection pool between the first acceleration node and the fourth acceleration node according to an identifier of the fifth network connection; sending the third data packet to the fourth acceleration node according to the sixth network connection; and separately storing corresponding relationships between the third session identifier and the transmission type of the third data packet and between the third session identifier and an identifier of the third acceleration node, and storing a corresponding relationship between the identifier of the fifth network connection and an identifier of the sixth network connection.

Further, the third forwarding module 1360 is used for: acquiring an identifier of the third acceleration node according to the third session identifier included in the second response data packet; and selecting one network connection from a connection pool between the first acceleration node and the third acceleration node to send the second response data packet to the third acceleration node. Alternatively, the third forwarding module 1360 is further used for: acquiring an identifier of the fifth network connection according to the third session identifier included in the second response data packet; and sending the second response data packet to the third acceleration node through the fifth network connection.

According to the apparatus in FIG. 13, fast forwarding of the response data packet can be implemented, and data transmission efficiency can be improved.

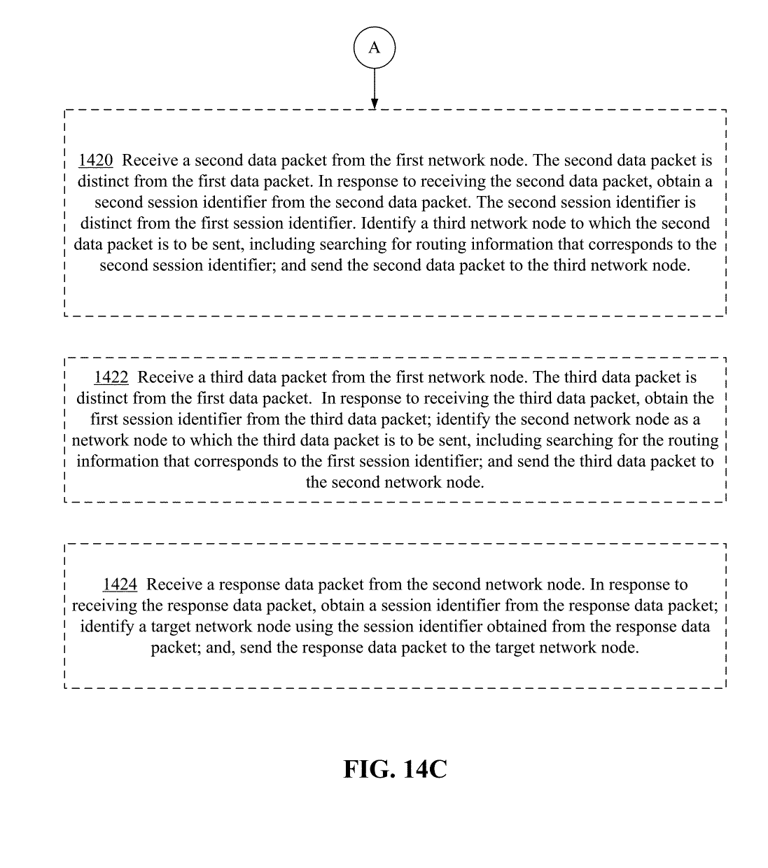

FIGS. 14A-14C are flow diagrams illustrating a method 1400 for routing a data packet in accordance with some embodiments.

The method 1400 is performed at an acceleration node (e.g., the node 100, FIG. 2A) with one or more processors and memory.

The node receives (1402) a first data packet from a first network node. For example, the node receives a data packet from a client (e.g., client 11, FIG. 1) or another acceleration node.

The node, in response to receiving the first data packet, obtains (1404) a first session identifier from the first data packet. For example, the node obtains the first session identifier by parsing the first data packet.

The node identifies (1406) a second network node to which the first data packet is to be sent, including searching for routing information that corresponds to the first session identifier. For example, the node searches for the routing information that corresponds to the first session identifier, and in accordance with a determination that the routing information that corresponds to the first session identifier exists (e.g., the routing information that corresponds to the first session identifier is stored in the node), identifies the second network node using the routing information that corresponds to the first session identifier (e.g., the routing information that corresponds to the first session identifier includes information identifying the second network node). In some embodiments, the second network node is another acceleration node (e.g., acceleration node 22, FIG. 1). In some embodiments, the second network node is an application server (e.g., application server 30, FIG. 1).

In some embodiments, the node determines (1408, FIG. 14B) whether the routing information that corresponds to the first session is stored in the acceleration node. In accordance with a determination that the routing information that corresponds to the first session identifier is not stored in the acceleration node, the node stores the first session identifier in association with the second network node. For example, the node stores the second network node in routing information that corresponds to the first session identifier. In some embodiments, in accordance with a determination that the routing information that corresponds to the first session identifier is not stored in the acceleration node, the node identifies a network node, of one or more network nodes connected to the node, to which the first data packet is to be sent as the second network node and. In some embodiments, the second network node is located between the node and the application server.

In some embodiments, the node determines (1410) whether the routing information that corresponds to the first session identifier is stored in the acceleration node. In accordance with a determination that the routing information that corresponds to the first session identifier is stored in the acceleration node, the node foregoes storing of the first session identifier in association with the second network node. Because the node already stores the routing information that corresponds to the first session identifier, it is not necessary for the node to store again the first session identifier in association with the second network node.

In some embodiments, the node identifies (1412) the second network node from the routing information that corresponds to the first session identifier. For example, the node determines the second network node from the routing information that corresponds to the first session identifier (e.g., the node extracts information identifying the second network node from the routing information that corresponds to the first session identifier).

The node determines (1414) a transmission type of the first data packet from the first network node to the second network node. For example, the node determines whether the first network node is a client or an acceleration node and whether the second network node is an acceleration node or an application server, and determines the transmission type in accordance with Table 1 described above.

In some embodiments, the node determines (1416) whether the transmission type of the first data packet corresponds to a transmission from a client to an acceleration node (e.g., “access” transmission type). The node determines whether the transmission type of the first data packet corresponds to a transmission from a client to an application server (e.g., “access+session” transmission type). The node determines whether the transmission type of the first data packet corresponds to a transmission from an acceleration node to an acceleration node (e.g., “transmission” transmission type). The node determines whether the transmission type of the first data packet corresponds to a transmission from an acceleration node to an application server (e.g., “session” transmission type).

The node sends (1418, FIG. 14A) the first data packet to the second network node.

In some embodiments, the node receives (1420, FIG. 14C) a second data packet from the first network node. The second data packet is distinct from the first data packet. In response to receiving the second data packet, the node obtains a second session identifier from the second data packet. The second session identifier is distinct from the first session identifier. The node identifies a third network node to which the second data packet is to be sent, including searching for routing information that corresponds to the second session identifier; and sends the second data packet to the third network node. For example, the second data packet follows a route that is different from the route for the first data packet.

In some embodiments, the node receives (1422) a third data packet from the first network node. The third data packet is distinct from the first data packet. In response to receiving the third data packet, the node obtains the first session identifier from the third data packet; identifies the second network node as a network node to which the third data packet is to be sent, including searching for the routing information that corresponds to the first session identifier; and sends the third data packet to the second network node. For example, when the third data packet and the first data packet correspond to the same session identifier (e.g., the first session identifier), the third data packet follows the same route as the first data packet.

In some embodiments, the node receives (1424) a response data packet from the second network node. In response to receiving the response data packet, the node obtains a session identifier from the response data packet; identifies a target network node using the session identifier obtained from the response data packet; and, sends the response data packet to the target network node. For example, in accordance with a determination that the response data packet corresponds to the first session identifier, the response data packet is sent to the first network node. This allows data packets that correspond to the same session identifier to follow the same route to and from the application server.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles described herein and their practical applications, to thereby enable others skilled in the art to best utilize the principles and various embodiments with various modifications as are suited to the particular use contemplated.

What is claimed is:

1. A method for routing a data packet, comprising:
at an acceleration node with one or more processors and memory:
receiving a first data packet from a first network node; and,
in response to receiving the first data packet:
obtaining a first session identifier from the first data packet;
identifying a second network node to which the first data packet is to be sent, including searching for routing information that corresponds to the first session identifier; and
sending the first data packet to the second network node.

2. The method of claim 1, further comprising:
determining whether the routing information that corresponds to the first session identifier is stored in the acceleration node; and,
in accordance with a determination that the routing information that corresponds to the first session identifier is not stored in the acceleration node, storing the first session identifier in association with the second network node.

3. The method of claim 1, further comprising:
determining whether the routing information that corresponds to the first session identifier is stored in the acceleration node; and,
in accordance with a determination that the routing information that corresponds to the first session identifier is stored in the acceleration node, foregoing storing of the first session identifier in association with the second network node.

4. The method of claim 3, including identifying the second network node from the routing information that corresponds to the first session identifier.

5. The method of claim 1, further comprising:
determining whether a transmission type of the first data packet corresponds to a transmission from a client to an acceleration node;
determining whether the transmission type of the first data packet corresponds to a transmission from a client to an application server;
determining whether the transmission type of the first data packet corresponds to a transmission from an acceleration node to an acceleration node; and
determining whether the transmission type of the first data packet corresponds to a transmission from an acceleration node to an application server.

6. The method of claim 1, further comprising:
receiving a second data packet from the first network node, wherein the second data packet is distinct from the first data packet; and,
in response to receiving the second data packet:
obtaining a second session identifier from the second data packet, wherein the second session identifier is distinct from the first session identifier;
identifying a third network node to which the second data packet is to be sent, including searching for routing information that corresponds to the second session identifier; and
sending the second data packet to the third network node.

7. The method of claim 1, further comprising:
receiving a third data packet from the first network node, wherein the third data packet is distinct from the first data packet; and,
in response to receiving the third data packet:
obtaining the first session identifier from the third data packet;
identifying the second network node as a network node to which the third data packet is to be sent, including searching for the routing information that corresponds to the first session identifier; and
sending the third data packet to the second network node.

8. The method of claim 1, further comprising:
receiving a response data packet from the second network node; and,
in response to receiving the response data packet:
obtaining a session identifier from the response data packet;
identifying a target network node using the session identifier obtained from the response data packet; and,
sending the response data packet to the target network node.

9. An acceleration node for routing a data packet, comprising:
one or more processors; and
memory storing one or more programs for execution by the one or more processors, the one or more programs including instructions for:
receiving a first data packet from a first network node; and,
in response to receiving the first data packet:
obtaining a first session identifier from the first data packet;
identifying a second network node to which the first data packet is to be sent, including searching for routing information that corresponds to the first session identifier; and
sending the first data packet to the second network node.

10. The acceleration node of claim 9, wherein the one or more programs include instructions for:
determining whether the routing information that corresponds to the first session identifier is stored in the acceleration node; and,
in accordance with a determination that the routing information that corresponds to the first session identifier is not stored in the acceleration node, storing the first session identifier in association with the second network node.

11. The acceleration node of claim 9, wherein the one or more programs include instructions for:
determining whether the routing information that corresponds to the first session identifier is stored in the acceleration node; and,
in accordance with a determination that the routing information that corresponds to the first session identifier is stored in the acceleration node, foregoing storing of the first session identifier in association with the second network node.

12. The acceleration node of claim 9, wherein the one or more programs include instructions for:
determining whether a transmission type of the first data packet corresponds to a transmission from a client to an acceleration node;
determining whether the transmission type of the first data packet corresponds to a transmission from a client to an application server;
determining whether the transmission type of the first data packet corresponds to a transmission from an acceleration node to an acceleration node; and
determining whether the transmission type of the first data packet corresponds to a transmission from an acceleration node to an application server.

13. The acceleration node of claim 9, wherein the one or more programs include instructions for:
receiving a second data packet from the first network node, wherein the second data packet is distinct from the first data packet; and,
in response to receiving the second data packet:
obtaining a second session identifier from the second data packet, wherein the second session identifier is distinct from the first session identifier;
identifying a third network node to which the second data packet is to be sent, including searching for routing information that corresponds to the second session identifier; and
sending the second data packet to the third network node.

14. The acceleration node of claim 9, wherein the one or more programs include instructions for:
receiving a third data packet from the first network node, wherein the third data packet is distinct from the first data packet; and,
in response to receiving the third data packet:
obtaining the first session identifier from the third data packet;
identifying the second network node as a network node to which the third data packet is to be sent, including searching for the routing information that corresponds to the first session identifier; and
sending the third data packet to the second network node.

15. The acceleration node of claim 9, wherein the one or more programs include instructions for:
receiving a response data packet from the second network node; and,
in response to receiving the response data packet:
obtaining a session identifier from the response data packet;
identifying a target network node using the session identifier obtained from the response data packet; and,
sending the response data packet to the target network node.

16. A non-transitory computer readable storage medium for routing a data packet, the computer readable storage medium storing:
one or more programs for execution by one or more processors of an acceleration node, the one or more programs including instructions for:
receiving a first data packet from a first network node; and,
in response to receiving the first data packet:
obtaining a first session identifier from the first data packet;
identifying a second network node to which the first data packet is to be sent, including searching for routing information that corresponds to the first session identifier; and
sending the first data packet to the second network node.

17. The computer readable storage medium of claim 16, wherein the one or more programs include instructions for:
determining whether the routing information that corresponds to the first session identifier is stored in the acceleration node; and,
in accordance with a determination that the routing information that corresponds to the first session identifier is not stored in the acceleration node, storing the first session identifier in association with the second network node.

18. The computer readable storage medium of claim 16, wherein the one or more programs include instructions for:
determining whether the routing information that corresponds to the first session identifier is stored in the acceleration node; and,
in accordance with a determination that the routing information that corresponds to the first session identifier is stored in the acceleration node, foregoing storing of the first session identifier in association with the second network node.

19. The computer readable storage medium of claim 16, wherein the one or more programs include instructions for:
determining whether a transmission type of the first data packet corresponds to a transmission from a client to an acceleration node;
determining whether the transmission type of the first data packet corresponds to a transmission from a client to an application server;
determining whether the transmission type of the first data packet corresponds to a transmission from an acceleration node to an acceleration node; and
determining whether the transmission type of the first data packet corresponds to a transmission from an acceleration node to an application server.

20. The computer readable storage medium of claim 16, wherein the one or more programs include instructions for:
receiving a response data packet from the second network node; and,
in response to receiving the response data packet:
obtaining a session identifier from the response data packet;
identifying a target network node using the session identifier obtained from the response data packet; and,
sending the response data packet to the target network node.
